(19) United States
(12) Patent Application Publication
(10) Pub. No.: US 2007/0141299 A1
(43) Pub. Date: Jun. 21, 2007

(54) Fabrics having stiff fibers and high-absorbable fibers arranged alternatively and mop thereof

(76) Inventor: Kyung Jack Hong, Kyungki-do (KR)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/581,816

(22) PCT Filed: Sep. 24, 2004
(86) PCT No.: PCT/KR04/02483

§ 371 Date: Nov. 16, 2006

(30) Foreign Application Priority Data
Dec. 2, 2003 (KR) 10-2003-0086674

(51) Int. Cl. B32B 3/06; B32B 33/00; A47L 17/08; D03D 13/00

(52) U.S. Cl. 428/97; 15/228; 442/189; 442/301; 442/203; 428/99

(57) ABSTRACT

The present invention relates to a fabric having stiff fibers and high-absorbable fibers alternatively arranged, in which said stiff fibers of polypropylene, polyethylene and the like, said high-absorbable fibers of polyester microfibers, polyester-nylon composite microfibers and the like having a size of 1.0 denier or less are weaved/knitted and processed according to a known method such as circular-knitting, weaving or tufting, in such a manner that a stiff fiber region of aggregated stiff fibers and a super-absorbent fiber region of aggregated high-absorbable fibers are alternatively arranged. By the fabric, it is possible to perform sweeping and wiping at the same time upon the cleaning of an indoor place. Also, it relates to a mop cloth for indoor cleaning comprising a fabric with stiff fibers and high-absorbable fibers alternatively arranged and a sheet with a Velcro tape formed on one surface thereof to be laminated on the fabric, in which the fabric and the sheet are joined by a finishing treatment such as overlocking or stitching. The mop cloth can be more rapidly attached to a holder connected to an end of a mop stick by a hinge or detached therefrom.

### TECHNICAL FIELD

The present invention relates to a fabric having stiff fibers and high-absorbable fibers arranged alternatively and a mop cloth using the same. More particularly, the present invention relates to a fabric having stiff fibers and high-absorbable fibers arranged alternatively, which can perform sweeping and wiping at the same time upon the cleaning of an indoor place and is readily attached to a mop cloth holder of a mop, and a mop cloth using the same.

### BACKGROUND ART

Conventional fabrics, even though they are developed for cleaning, is generally constructed to provide absorbancy or high absorbancy so that they can be used only for exclusive wiping to remove fine dust while being wet or not being wet. Therefore, most of the ordinary cleaning work is conducted by separately sweeping a surface to be cleaned by a broomstick or a vacuum cleaner prior to wiping with a cloth such as those commonly used for wiping, for example a duster. Thus, in case of an ordinary cleaning for an indoor place, at least two operations of sweeping and wiping should be sequentially carried out, which makes the cleaning vexatious.

Furthermore, conventional mop clothes are fixed onto a holder part of a mop stick using a separate jig disposed at the holder part and should be separated from the holder part for washing.

Accordingly, the present inventors have developed a novel fabric which can conduct sweeping and wiping at the same time for cleaning of an indoor space where contamination is not heavy and have completed this invention.

### DISCLOSURE OF THE INVENTION

[Technical Objects ]

It is an object of the present invention to provide a fabric with stiff fibers and high-absorbable fibers arranged alternatively which has a structure comprising a stiff fiber region and a super-absorbent fiber region alternatively arranged so that sweeping and wiping can be carried out simultaneously in a single cleaning.

It is another object of the present invention to provide a mop cloth using the fabric with stiff fiber and super-absorbent fiber alternatively arranged which comprises the fabric with stiff fibers and high-absorbable fibers alternatively arranged and a sheet with a Velcro tape, fixed at one side of the fabric by overlooking or stitching, whereby it can be rapidly and readily separated from and attached to a mop stick, particularly a mop cloth holder connected to the lower end of the mop stick by a hinge.

[Technical Solution]

In accordance with the present invention, the above and other objects can be accomplished by the provision of a fabric with stiff fibers and high-absorbable fibers alternatively arranged in which the stiff fibers of polypropylene, polyethylene, polyester, nylon and the like, the high-absorbable fibers of polyester microfibers, polyester-nylon composite microfibers and the like having a size of 1.0 denier or less are weaved/knitted and processed according to a known method such as circular-knitting, weaving or tufting, in such a manner that a stiff fiber region of aggregated stiff fibers and a super-absorbent fiber region of aggregated high-absorbable fibers are alternatively arranged.

Also, the fabric with stiff fibers and high-absorbable fibers alternatively arranged according to the present invention has an area ratio of the stiff fiber region to the super-absorbent fiber region of 10 to 50:50 to 90.

The mop cloth using the fabric with stiff fibers and high-absorbable fibers alternatively arranged according to the present invention comprises the fabric with stiff fibers and high-absorbable fibers alternatively arranged, cut to have a predetermined area, and a sheet with a fastening means on its surface, sequentially laminated on the fabric, in which the fabric and the sheet is joined at their margins by overlooking or stitching with a cloth wrapped around their margins. It can be used as a mop cloth which can be readily attached to and detached from a mop stick.

Also, in the mop cloth using the fabric with stiff fiber and super-absorbent fiber alternatively arranged according to the present invention, the fastening means formed on one surface of the sheet is a hook part or a loop part of a Velcro tape.

[Advantageous Effects]

Therefore, by using the fabric according to the present invention having a structure comprising a stiff fiber region and a super-absorbent fiber region alternatively arranged to conduct sweeping and wiping at the same time, it is possible to more effectively and conveniently to perform sweeping and wiping at the same time to complete a cleaning operation in a single swabbing.

Further, by using the mop cloth according to the present invention comprising the fabric with stiff fibers and high-absorbable fibers and a sheet with a Velcro tape formed on one surface thereof, laminated on the fabric, in which the fabric and the sheet are joined by overlooking or stitching with a cloth wrapped around their margins, it is possible to more rapidly and readily accomplish the attachment of the mop cloth to a holder connected to one end of a mop stick by a hinge or detachment therefrom.

### BRIEF DESCRIPTION OF THE DRAWINGS

FIG. 1 is a plane view illustrating the fabric having stiff fibers and high-absorbable fibers alternatively arranged according to the present invention;

FIG. 2 is a perspective view illustrating a mop cloth using the fabric having stiff fibers and high-absorbable fibers alternatively arranged according to the present invention; and

FIG. 3 is a perspective view illustrating an example using the mop cloth using the fabric having stiff fibers and high-absorbable fibers alternatively arranged according to the present invention, in which the mop is to be attached to a mop cloth holder connected to a mop stick.

### BEST MODE FOR CARRYING OUT THE INVENTION

Now, the present invention will be described in detail hereinafter in conjunction with the accompanying drawings.

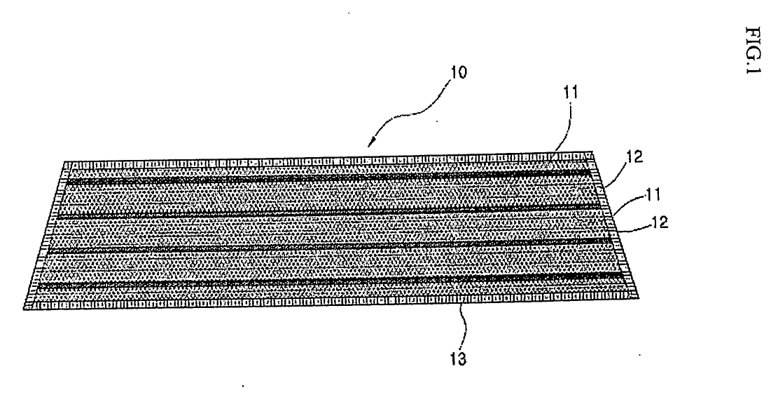

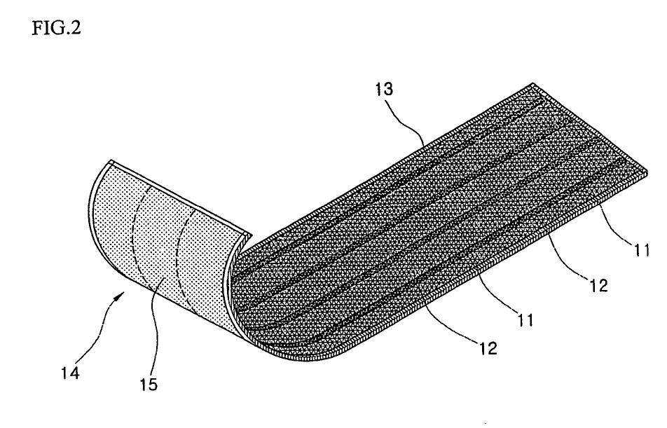

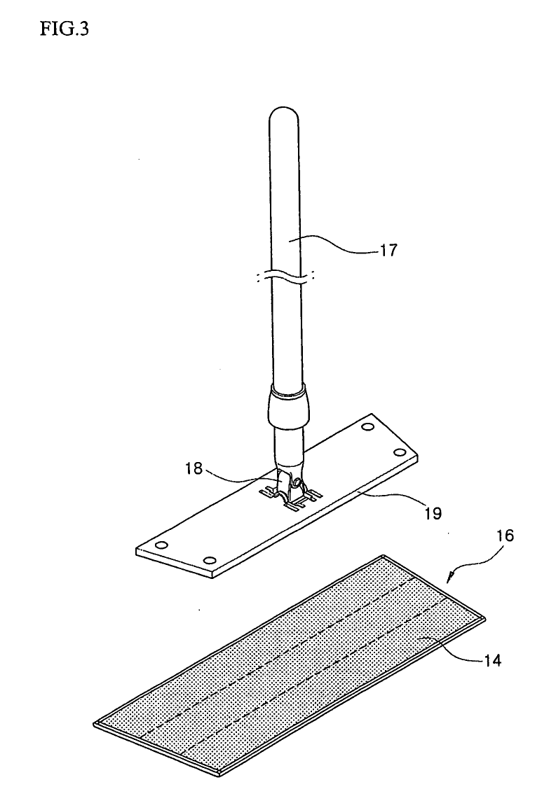

FIG. 1 is a plane view illustrating the fabric having stiff fibers and high-absorbable fibers arranged alternatively according to the present invention, FIG. 2 is a perspective view illustrating a mop cloth using the fabric having stiff fibers and high-absorbable fibers arranged alternatively according to the present invention, and FIG. 3 is a perspective view illustrating an example using a mop cloth comprising the fabric having stiff fibers and high-absorbable fibers arranged alternatively according to the present invention, in which the mop cloth is to be attached to a mop cloth holder connected to a mop stick.

Referring to FIG. 1, the fabric 10 with stiff fibers and high-absorbable fibers alternatively arranged is manufactured and processed by circular-knitting, weaving or tufting stiff fibers, for example polypropylene, polyethylene, polyester, nylon and the like, and high-absorbable fibers, for example polyester microfibers, polyester-nylon composite microfibers of 1.0 denier or less, according to a known method, in which the fabric has a structure comprising a stiff fiber region 11 of aggregated stiff fibers and a super-absorbent fiber region 12 of aggregated high-absorbable fibers alternatively arranged.

The term “stiff fibers”, as used herein, refers to long fibers which are yarns having physical properties such as a high bending strength and a high resiliency and are typically obtained by thickly spinning vinylic synthetic fibers. In the present invention, the stiff fibers are not limited by raw materials of fibers but any of stiff synthetic fibers can be used. Examples of stiff fibers which can be preferably used in the present invention include polypropylene fibers, polyethylene fibers, polyester fibers and nylon fibers. Particularly, the polypropylene fibers have little water absorbancy, high resiliency and excellent mechanical properties.

The high-absorbable fibers refer to fibers of a high water retention rate, such as polyester microfibers or polyester-nylon composite microfibers having a diameter of 1.0 denier or less. Preferably, examples of the high-absorbable fibers include polyester fibers that can be readily formed into microfibers by spinning and splitting. It should be understood that the high-absorbable fibers useful in the present invention can be any of the known commercially available from domestic and foreign companies.

According to the present invention, the fabric has a structure, in which the stiff fiber region 11 comprising aggregated stiff fibers and the super-absorbent fiber region 12 comprising aggregated high-absorbable fibers are alternatively arranged to each other by circular-knitting, weaving and tufting according to a known method.

The fabric can be manufactured by circular-knitting, weaving and tufting the stiff fiber region 11 of aggregated stiff fiber and the super-absorbent fiber region 12 of aggregated stiff fiber according to a known method, in a fashion that alternatively arranges the stiff fiber region 11 and the super-absorbent fiber 12 with each other. That is, the structure of the fabric according to the present invention can be accomplished by control the arrangement of the general fibers introduced to knitting or weaving machine.

In the fabric according to the present invention, the stiff fiber region 11 functions as a broom for sweeping and the super-absorbent fiber region 12 functions as a duster for wiping. Since the fabric according to the present invention has a structure comprising the stiff fiber region 11 and the super-absorbent fiber region 12 alternatively arranged, when a user swabs the floor of an indoor place with the fabric, sweeping and wiping required for cleaning operation can be done at the same time and thus, the user can carry out the sweeping and wiping operations simultaneously in a single swabbing operation.

Of course, it may be preferably to remove filth or dirt with a big size by a vacuum cleaner and the like prior to cleaning by the fabric, when contamination is heavy. However, in case of cleaning most indoor places, particularly floors or rooms of oriental houses, the sweeping and wiping operations can be conveniently conducted by a single swabbing with the fabric to complete the cleaning.

Also, in the fabric 10 comprising stiff fibers and super-absorbent fabrics, the area ration of the stiff fiber region 11 to the super-absorbent fiber region 12 is 10 to 50:50 to 90.

Preferably, the stiff fiber region 11 has an area proportion of 10 to 50% relative to the super-absorbent fiber region 12. This is because the sweeping operation only pushs out dust and dirt to one side while the wiping operation adsorbs minute dust directly onto the super-absorbent fiber region 12. Thus, the super-absorbent fiber region 12 used for wiping operation during the cleaning is preferably larger than the stiff fiber region 11 used for sweeping operation.

However, when the stiff fiber region 11 is less than 10% based on the total area of the fabric 10, the sweeping operation cannot be carried sufficiently. When it exceeds 50%, the wiping operation is not carried out sufficiently and the fabric 10 should be washed for subsequent use.

Also, the fabric can further comprise a finishing region at the margin treated by overlooking or stitching with a cloth wrapped around the margin. By this finishing region, the fabric (the duster) can maintain its original shape without fraying at the margin.

Particularly, as shown in FIG. 2, the fabric 10 according to the present invention, cut to have a predetermined area, is provided and a sheet 14 with a fastening means 15 formed on one surface thereof is laminated on the fabric in such a manner that the surface formed with the fastening means is exposed to the outside. The laminate of the fabric 10 and the sheet 14 is overlooked at its margin or stitched with a cloth wrapped around the margin to form a mop cloth with a finishing region 13. By the treatment of overlooking or stitching with a cloth wrapped, it is possible to produce a duster or mop cloth of a woven or knitted fabric which can maintain an original shape without fraying at the margin.

The fastening means formed on one surface of the sheet 14 can be selected from a hook part and a loop part of a Velcro tape.

FIG. 3 is a perspective view illustrating an example using a mop cloth using the fabric having stiff fibers and high-absorbable fibers arranged alternatively according to the present invention; in which the mop cloth is to be attached to a mop cloth holder connected to a mop stick. A holder 19 having a predetermined area is connected to an end of a mop stick by a hinge in such a manner as to be rotated back and forth and right and left. At the bottom of the holder 19, there is formed a mate part of the Velcro tape 15 to be fastened to the other part of the Velcro tape 15 provided on the sheet 14 of the mop cloth 16. Accordingly, the mop cloth 16 can readily attached to and detached from the holder 19 of the mop.

### MODE FOR CARRYING OUT THE INVENTION

### EXAMPLE 1

500d/11f dope-dyed polypropylene filament yarn, 100d/192f 4-ply polyester microfiber yarn (185 tpm) and 150d/144f 3-ply polyester microfiber yarn (185 tpm) were knitted on a circular knitting machine for knitting a pile fabric with an areal ratio of the fibers of 30:35:35. The resulting piles were cut, scoured and dyed in a high-pressure jet dying machine. The backside of the fabric was coated with polyurethane so that the pile did not fall out. Thus, the knitted pile fabric with a stiff fiber region and a super-absorbent fiber region according to the present invention was fabricated.

The knitted fabric thus obtained was cut into pieces with a predetermined size and each piece was laminated with a sheet having a Velcro tape as fastening means formed on a surface. The resulting laminate was finished with overlooked seams at its edge to form a dustcloth.

### EXAMPLE 2

500d/11f 6-ply dope-dyed polypropylene filament yarn, 150d/144f 20-ply polyester microfiber yarn were knitted on a Tufting machine to form a pile fabric with an areal ratio of the fibers of 15:85, followed by cutting. The backside of the fabric was coated with polyurethane so that the pile did not fall out. Thus, the woven pile fabric with a stiff fiber region and a super-absorbent fiber region according to the present invention was fabricated.

The woven fabric thus obtained was cut into pieces with a predetermined size and each piece was laminated with a sheet having a Velcro tape as a fastening means formed on a surface. The resulting laminate was finished with overlooked seams at its edge to form a dustcloth.

### INDUSTRIAL APPLICABILITY

The fabric having a structure comprising a stiff fiber region and a super-absorbent fiber region alternately arranged to conduct sweeping and wiping at the same time upon the cleaning of an indoor place according to the present invention is suitable for a duster to conduct sweeping and wiping at the same time for cleaning of an indoor space where contamination is not heavy.

Although the present invention has been explained in detail by an embodiment described above, those skilled in the art will appreciate that various modifications additions and substitutions are possible, without departing from the scope and spirit of the invention as disclosed in the accompanying claims.

What is claimed is:

1. A fabric with stiff fibers and high-absorbable fibers alternatively arranged, wherein said stiff fibers of synthetic fibers including polypropylene, polyethylene, polyester, nylon or the like, and said high-absorbable fibers of microfibers including polyester microfibers, polyester-nylon composite microfibers and the like having a size of 1.0 denier or less are weaved/knitted and processed according to a known method such as circular-knitting, weaving or tufting, in such a manner that a stiff fiber region of aggregated stiff fibers and a super-absorbent fiber region of aggregated high-absorbable fibers are alternatively arranged.

2. The fabric according to claim 1, wherein the area ratio of said stiff fiber region to said super-absorbent fiber region is 10 to 50:50 to 90.

3. A mop cloth using the fabric with stiff fibers and high-absorbable fibers alternatively arranged according to claim 1, which comprises the fabric, cut to have a predetermined area, and a sheet with a fastening means formed on one surface thereof to be laminated on the fabric, and wherein said fabric and the sheet are overlooked at their margins or stitched with a cloth wrapped around their margins.

4. The mop cloth according to claim 3, wherein said fastening means formed on one surface of the sheet is a hook part or a loop part of a Velcro tape.
